(19) United States
(12) Patent Application Publication
(10) Pub. No.: US 2024/0021936 A1
(43) Pub. Date: Jan. 18, 2024

(54) BATTERY HOUSING, BATTERY, AND ELECTRONIC DEVICE

(71) Applicant: BYD COMPANY LIMITED, Shenzhen (CN)

(72) Inventors: Guosheng TANG, Shenzhen (CN); Liwei LIANG, Shenzhen (CN); Shumin HU, Shenzhen (CN); Jian ZHANG, Shenzhen (CN); Jinzhong OUYANG, Shenzhen (CN)

(21) Appl. No.: 18/373,963

(22) Filed: Sep. 28, 2023

Related U.S. Application Data
(63) Continuation of application No. PCT/CN2022/097167, filed on Jun. 6, 2022.

(30) Foreign Application Priority Data
Jun. 24, 2021 (CN) 202121412769.6

(51) Int. Cl. H01M 50/202; H01M 50/271; H01M 50/224

(52) U.S. Cl. CPC H01M 50/202; H01M 50/271; H01M 50/224

(57) ABSTRACT

A battery housing includes an upper housing and a lower housing. The lower housing includes a bottom portion and first side walls, the first side walls extend upward from edges of the bottom portion, the bottom portion and the first side walls enclose a cavity, and at least one of the first side walls having a first flange on an end of the first side wall away from the bottom portion. The upper housing is located above the lower housing, the upper housing includes a top portion and a second flange, a second concave structure is disposed at a joint between the second flange and the top portion, the first flange is in contact with the second flange by welding to obtain melt, and the melt is disposed in the second concave structure.

### CROSS-REFERENCE TO RELATED APPLICATIONS

This application is a Continuation Application of International Patent Application No. PCT/CN2022/097167, filed on Jun. 6, 2022, which is based on and claims priority to and benefits of Chinese Patent Application No. 202121412769.6, filed on Jun. 24, 2021. The entire content of all of the above-referenced applications is incorporated herein by reference.

### FIELD

The present disclosure belongs to the field of electronic device technologies, and more particularly, to a battery housing, a battery, and an electronic device.

### BACKGROUND

A battery energy density stands for a given electrochemical energy storage device, a ratio of energy that can be charged to a mass or volume of an energy storage medium. From a lead-acid battery, a nickel-cadmium battery, a nickel-hydrogen battery, to a lithium-ion battery, the energy density is continuously improved. However, the improvement is not enough, compared to efficiency of development of a scale of operation of industrial companies, and compared to the market demand of human civilization for power. The battery energy density is an important indicator to determine quality of a battery, and therefore, to improve the battery energy density is a critical task for designing a battery. There is a need to effectively improve the battery energy density.

### SUMMARY

A battery housing, a battery, and an electronic device are disclosed.

To resolve the foregoing technical problem, according to a first aspect, an embodiment of the present disclosure provides a battery housing, which includes a lower housing and an upper housing. The lower housing includes a bottom portion and first side walls, the first side walls extend upward from edges of the bottom portion, the bottom portion and the first side walls enclose a cavity, and at least one of the first side walls having a first flange on an end of the first side wall away from the bottom portion. The upper housing is located above the lower housing, the upper housing includes a top portion and a second flange, a second concave structure is disposed at a joint between the second flange and the top portion, the first flange is in contact with the second flange by welding to obtain melt, and the melt is disposed in the second concave structure.

In an embodiment, an upper portion of at least one of the first side walls includes a first concave structure recessed toward the cavity.

In an embodiment, the first concave structure supports the second concave structure.

In an embodiment, the battery housing is configured to accommodate an electrode core, and a top surface of the melt does not exceed a top end of the top portion.

In an embodiment, the second concave structure is circular arc-shaped.

In an embodiment, the first concave structure is circular arc-shaped, and a width of the first concave structure is about twice a depth of the first concave structure.

In an embodiment, the depth of the first concave structure is less than or equal to a radius of a chamfer formed between the at least one of the first side walls and the bottom portion of the lower housing, or a width of the second concave structure is less than or equal to the radius of the chamfer.

In an embodiment, a length L of the first concave structure is determined according to the formula: L=L1−2e−p, where L1 is a length of the electrode core in the battery housing, an intersection between two of the first side walls of the lower housing has an arc shape, e is a radius of the arc shape, and p is a radiation distance of a hardening treatment for the lower housing.

In an embodiment, the lower housing or the upper housing comprises a metal.

In an embodiment, a thickness of the lower housing ranges from about 0.03 mm to about 0.15 mm, or a thickness of the upper housing ranges from about 0.03 mm to about 0.15 mm.

In an embodiment, the thickness of the upper housing is greater than or equal to the thickness of the lower housing.

In an embodiment, a rivet, an injection hole, and an injection hole sealing nail are disposed on the lower housing, and the injection hole sealing nail is configured to seal the injection hole.

In an embodiment, before the welding, a distance between the first concave structure and the first flange is equal to a depth of a recess of the second concave structure.

In an embodiment, the radiation distance of hardening treatment ranges from about 0.2 mm to about 0.5 mm.

In an embodiment, the first concave structure and the second concave structure have a semicircular shape, and a radius of the second concave structure is equal to a radius of the first concave structure.

According to a second aspect, an embodiment of the present disclosure provides a battery, which includes an electrode core and the battery according to the first aspect.

According to a third aspect, an embodiment of the present disclosure provides an electronic device, which includes the battery according to the second aspect.

In the battery housing in the embodiments of the present disclosure, the concave structure is disposed on the upper housing of the battery, and the flange are arranged/disposed on the upper housing of the battery and the lower housing of the battery. In this way, when the housings are welded, the flanges can be melted to form melt and the melt is disposed at the concave structure. Therefore, space occupied by the melt does not exceed the battery housing, so that the volume of space for accommodating an entire battery is reduced, to improve the energy density of the battery.

### BRIEF DESCRIPTION OF THE DRAWINGS

For a better understanding of the present invention, embodiments are described below, by way of non-limiting examples and with reference to the accompanying drawings, in which:

FIG. 1 is an exploded view of a structure of a battery according to an embodiment of the present disclosure;

FIG. 2 is a cross-sectional view of a battery housing according to an embodiment of the present disclosure;

FIG. 3 is a cross-sectional view of a battery housing according to another embodiment of the present disclosure;

FIG. 4 is a cross-sectional view of a battery housing after a flange is melted according to an embodiment of the present disclosure;

FIG. 5 is a cross-sectional view of a battery housing after a flange is melted according to another embodiment of the present disclosure;

FIG. 6 is a cross-sectional view of a battery housing after a flange is melted according to an embodiment of the present disclosure;

FIG. 7 is a cross-sectional view of a battery housing after a flange is melted according to another embodiment of the present disclosure;

FIG. 8 is a schematic diagram of dimensions of a first concave structure according to an embodiment of the present disclosure; and

FIG. 9 is a schematic diagram of a first flange and a second flange before melting according to an embodiment of the present disclosure.

### DETAILED DESCRIPTION

To make technical problems resolved by the present disclosure, technical solutions, and beneficial effects more comprehensible, the following further describes the present disclosure in detail with reference to the accompanying drawings and embodiments. It should be understood that the embodiments described herein are only used to explain the present disclosure and are not to limit the present disclosure.

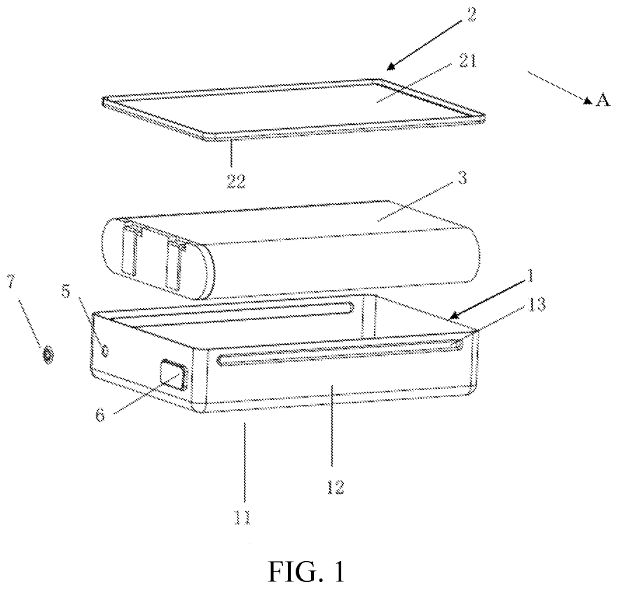

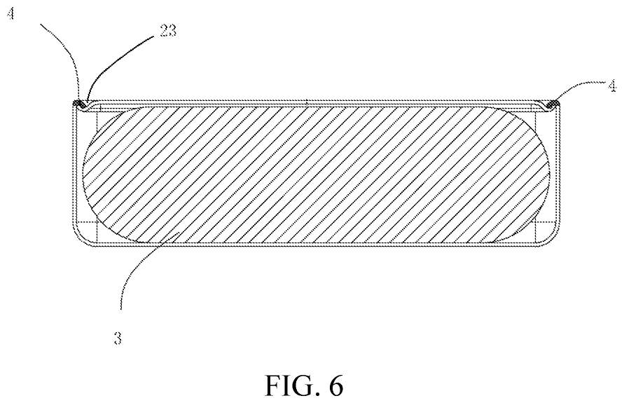

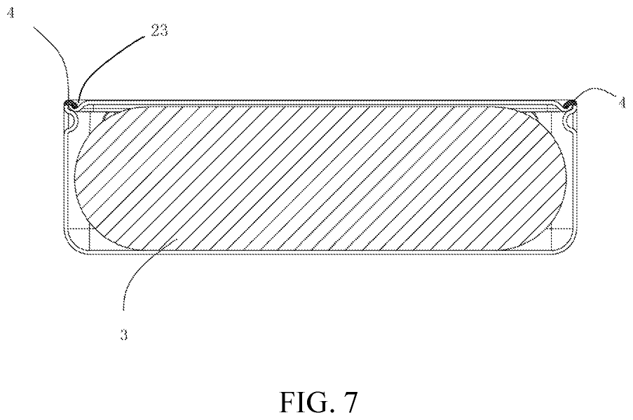

A battery housing and a battery of the present disclosure are described in detail below with reference to FIG. 1 to FIG. 9. The battery housing provided in the embodiments of the present disclosure includes a lower housing 1 and an upper housing 2. The lower housing 1 includes a bottom portion 11 and first side walls 12 (e.g., four first side walls 112). The first side walls 12 extend upward from the bottom portion 11, and the bottom portion 11 and the first side walls 12 enclose a cavity. At least one of the first side walls 12 has a first flange 14 on an end of the first side wall away from the bottom portion 11. The upper housing 2 is located above the lower housing 1. The upper housing 2 includes a top portion 21 and a second flange 24. There is a second concave structure 23 disposed at a joint between the second flange 24 and the top portion 21. The first flange 14 and the second flange 24 are in contact, so that when the upper housing 2 and the lower housing 1 are welded, the first flange 14 and the second flange 24 are melted to form melt 4 that is disposed in the second concave structure 23.

In the battery housing of the embodiments of the present disclosure, the concave structure is disposed/arranged on the upper housing of the battery, and the flanges are disposed/arranged on the lower housing and upper housing of the battery. In this way, when the upper housing and lower housings are welded, the flanges can be melted and the melt disposed into the concave structure. Therefore, space occupied by the melt does not exceed the top portion 21 of the battery housing, so that a volume for accommodating an entire battery is reduced, to improve the energy density of the battery.

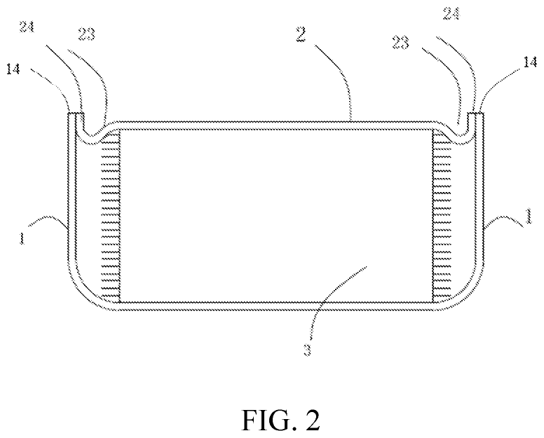

As shown in FIG. 2, the upper housing 2 includes the top portion 21 and the second flange 24, and there is the second concave structure 23 disposed at the joint between the second flange 24 and the top portion 21. In addition, it may also be understood that the upper housing 2 has a second side wall 22 surrounding the top portion 21. The second side wall 22 has a thickness. The second concave structure 23 is formed by stamping the second side wall 22. An end of the second concave structure 23 has the second flange 24, and the second flange 24 is a part of the second side wall 22. That is, before stamping, the upper housing 2 includes the top portion 21 and the second side wall 22. The second concave structure 23 and the second flange 24 are formed by stamping the second side wall 22. After stamping, the upper housing 2 includes the top portion 21, the second concave structure 23, and the second flange 24. When it is understood that the upper housing 2 has the second side wall 22, a height of the first side wall 12 of the lower housing 1 is greater than a height of the second side wall 22 of the upper housing 2. The height of the second side wall 22 of the upper housing 2 is small, and the upper housing 2 may be approximately a plate. In this embodiment of the present disclosure, a concave structure (for example, the second concave structure 23) is disposed/arranged on the upper housing 2 to improve an energy density. The concave structure may also be used as a reinforcing rib, thereby avoiding deformation of the lower housing 1 when welded.

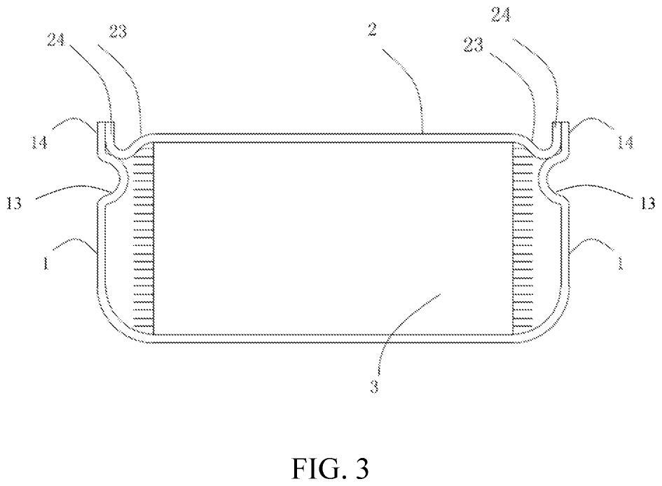

In some embodiments, as shown in FIG. 3, an upper portion of the first side wall 12 has a first concave structure 13 recessed toward the cavity. A concave structure (for example, the first concave structure 13) is arranged on the first side wall 12 of the lower housing 1 to improve the energy density, and the concave structure may also be used as a reinforcing rib to avoid deformation of the upper housing 2 during welding.

The first flange 14 may be a part of the first concave structure 13 extending toward an exterior of the battery housing in a direction perpendicular to a concave direction of the first concave structure 13. The second flange 24 may be a part extending toward the exterior of the battery housing in a direction parallel to the first flange 14. In some embodiments, dimensions of the first flange 14 and the second flange 24 are both small, so that the first flange 14 and the second flange 24 are connected when the housings are welded that melts a portion of the first flange 14 and the second flange 24.

The first side wall 12 has the first concave structure 13. The second concave structure 23 is disposed at the joint between the second flange 24 and the top portion 21. The concave structure (the first concave structure or the second concave structure) may be formed by stamping.

The first concave structure 13 supports the second concave structure 23. The first concave structure 13 can be configured to support the second concave structure 23. In this way, the first concave structure 13 has functions of support and positioning for assembling the battery, ensuring that when the battery housing is welded, the melt can flow into the second concave structure, to improve the energy density of the battery. In addition, the first concave structure 13 may also be used as a reinforcing rib when the lower housing 1 and the upper housing 2 are welded, to resist a stress of welding and avoid deformation of the housing.

When the first concave structure 13 and the second concave structure 23 are not in contact, the first concave structure 13 and the second concave structure 23 can prevent deformation of welding. When the first concave structure 13 and the second concave structure 23 are in contact, the first concave structure 13 and the second concave structure 23 can prevent the deformation of welding, and the first concave structure 13 can support the second concave structure 23.

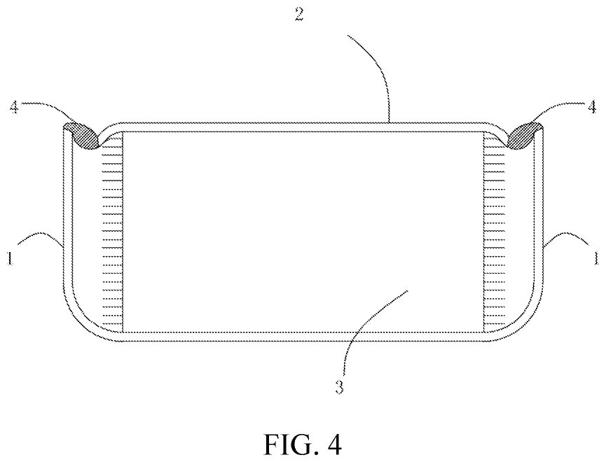

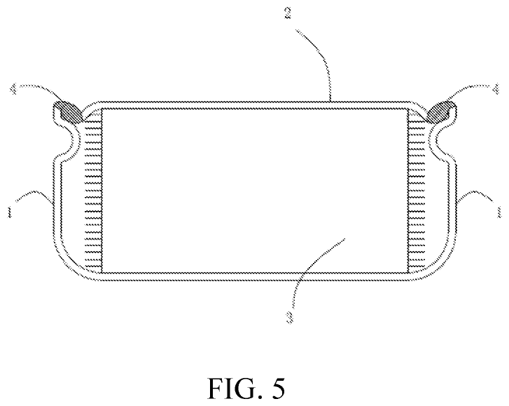

The battery housing is configured to accommodate an electrode core 3, and a height of melt 4 does not exceed the top portion 21, as shown in schematic structures in FIG. 4 and FIG. 5. After the upper housing and the lower housing are welded, the melt 4 flows into and is disposed in the second concave structure 23, space occupied by the melt 4 does not exceed space enclosed by the side wall of the battery housing, the top portion 21, and the bottom portion, and an entire dimension of the battery is not affected by the welding, such that the energy density of the battery can be improved.

The first flange 14 may be a part of the first concave structure 13 extending toward the exterior of the battery housing in a direction perpendicular to a concave direction of the first concave structure 13. The second flange 24 is a part of the second concave structure 23 extending toward the exterior of the battery housing in a direction parallel to the first flange 14. The dimensions of the first flange 14 and the second flange 24 are both small, so that the first flange 14 and the second flange 24 are connected (e.g., melted) when the housings are welded.

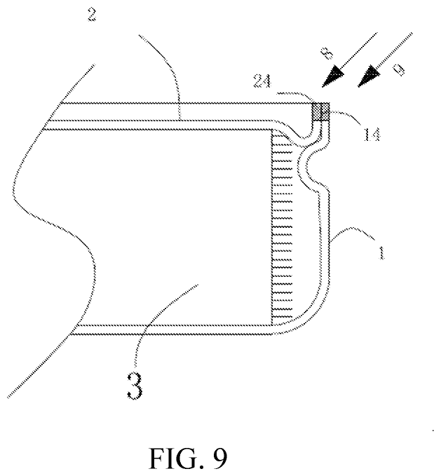

As shown in FIG. 9, an angle of emission of a laser 8 and an angle of blowing gas by a coaxial gas 9 can be controlled to control the melt 4 of the flange to flow into the second concave structure 23.

The second concave structure 23 may be circular arc-shaped. In some embodiments, a cross section of the second concave structure 23 may be semicircular. The cross section of the second concave structure 23 is a cross section obtained by taking the second concave structure 23 in a width direction (for example, a direction A as shown in FIG. 1) of the upper housing 2. The cross section of the second concave structure 23 is parallel to the width direction of the upper housing 2 and perpendicular to a surface of the top portion 21 of the upper housing 2.

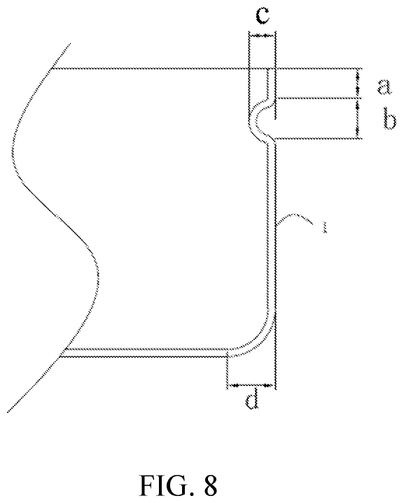

The first concave structure 13 may be circular arc-shaped, and the first concave structure 13 has a width about twice a depth. As shown in FIG. 8, b is the width, and c is the depth. For example, in some embodiments, when the cross section of the first concave structure 13 is semicircular, the width of the first concave structure 13 is a diameter of the semicircle, and the depth of the first concave structure 13 is a radius of the semicircle. The cross section of the first concave structure 13 is a cross section obtained by taking the second concave structure 23 in a width direction (for example, the direction A as shown in FIG. 1) of the lower housing 1. The cross section of the first concave structure 13 is parallel to the width direction of the lower housing 1 and perpendicular to a surface of the bottom portion 11 of the lower housing 1. Therefore, when the circular arc shape of the first concave structure 13 is a semicircle, the first concave structure 13 has the width twice the depth.

After the housing is welded and melted, a flange part is completely melted on the second concave structure 23, and a distance a between the first concave structure 13 and an original position of the first flange 14 is equal to the depth by which the second concave structure 23 is recessed inward. That is, the first concave structure 13 is located at a position at a distance of a from the first flange 14. In addition, the second concave structure 23 may be located inside the upper housing 2 that is connected to the second flange 24. In this configuration, the first concave structure 13 of the lower housing 1 and the second concave structure 23 of the upper housing 2 can be in contact.

When the first concave structure 13 and the second concave structure 23 are both circular arc-shaped. When the two circular arcs are both a semicircle and the two circular arcs have a same radius, the first concave structure 13 can be attached to the second concave structure 23 more tightly, thereby further strengthening positioning the entire battery and effectively preventing the electrode core 3 from scalding during welding.

The first side wall 12 may include two long side walls and two short side walls. The first concave structure 13 may be arranged on the long side walls, or may be arranged on the short side walls, or the first concave structure 13 may be arranged on both the long side walls and the short side walls. This is not limited in the present disclosure.

The concave structure (the first concave structure 13 or the second concave structure 23) may be used as a reinforcing rib to prevent the stress of welding when the battery housing is welded, to prevent deformation generated by welding.

The concave structure may be formed by stamping processing. The first concave structure 13 may have functions of support and positioning for the second concave structure 23. In addition, the first concave structure 13 and the second concave structure 23 can both resist the stress of welding, to restrain deformation of welding generated by welding.

When the housing is relatively thin, strength of a structural bending section is not enough to resist a thermal stress generated during welding by the laser 8, causing the section to be deformed. In a process that the concave structure is formed, an intense plastic deformation is generated near the concave, to implement the hardening treatment. Strength, hardness, and rigidity of a material is improved, so that energy of resisting a bending moment is significantly improved, to use a controlled concave deformation to restrain actual unwanted welding deformation.

In an embodiment, as shown in FIG. 8, the depth of the first concave structure 13 is less than or equal to a radius of a chamfer formed between a side surface on which the first concave structure 13 is located and the bottom portion 11 of the lower housing 1, and/or a width of the second concave structure 23 is less than or equal to the radius of the chamfer. For example, the radius of the chamfer R formed between the side surface on which the first concave structure 13 is located and the bottom portion 11 of the lower housing 1 is d, and for the first concave structure, c≤d. For the second concave structure 23, the width of the second concave structure 23 is less than or equal to d. The depth of the first concave structure 13 and the width of the second concave structure 23 are set to be less than or equal to d, so that the concave structure does not occupy much space in the battery, to effectively improve the energy density of the battery.

A length L of the first concave structure 13 is determined according to the following formula: L=L1−2e−p, where L1 is a length of the electrode core, an intersection between two of four first side walls 12 of the lower housing 1 has an arc shape, e is a radius of the arc shape, and p is a radiation distance of hardening treatment of the lower housing and is related to a processing force, a temperature, a deformation speed, and other factors. the longer the length of the first concave structure 13 as a reinforcing rib is, the larger a region for hardening treatment is. But an R angle is formed between a long side and a short side. If the reinforcing rib extends, strength of the R angle is affected. Therefore, the length of the first concave structure 13 needs to be set to satisfy the strength of the R angle and satisfy a size of a hardening treatment region. Generally, p is set as about 0.2 mm to about 0.5 mm. Such setting is enough to make the concave structure close to a welding seam as much as possible, to generate enough capability for resisting the bending moment. When the first concave structure 13 is formed by stamping, a surrounding region of the first concave structure 13 generates a plastic deformation to form a radiation region of hardening treatment around the first concave structure 13. A distance between a first end of the first concave structure 13 and an end of the radiation region of hardening treatment close to the first end in a length direction of the first concave structure 13 is the radiation distance of hardening treatment. The first end may be any end of the first concave structure 13 in the length direction of the first concave structure 13.

The configuration of the first concave structure 13 can resist a stress generated by welding, to prevent deformation of the housing, and can provide positioning for assembling the battery, to prevent light exposure during welding of the battery from scalding the electrode core 3 and prevent molten slag from falling inside the cavity.

After the upper housing 2 and the lower housing 1 are in contact by the first concave structure 13 and the second concave structure 23, a pressurization deformation manner can be used to connect the housings. The length of the second concave structure 23 is designed to provide a positioning reference line for pressurization formation, so that a pressurization fixture does not press an edge of the housing to damage the battery. The second concave structure 23 on the upper housing 2 is used as a reinforcing rib, and the arc of the second concave structure 23 has a cushioning effect during formation, so that a force generated by formation does not pull a melted edge, avoiding deformation of welding and protect the melted edge of welding.

Materials of the upper housing 2 and the lower housing 1 may be metal. For example, the material of the lower housing 1 is steel or alloy, and the material of the upper housing 2 is steel or alloy. In an embodiment, the materials of the lower housing 1 and the upper housing 2 may be stainless steel, or may be aluminum alloy, nickel alloy, chromium alloy, or the like. The housing is made of a metal material. A metal housing has good sealing performance, metal has high strength and is not easy to break, and size processing tolerance of metal is small, facilitating improving the energy density.

Different thicknesses of a housing have different pulling capabilities, and an appropriate thickness of a housing can be selected according to a thickness and capacity of a battery. The thickness of the housing needs to meet packaging requirements, and needs to be set as not excessively thick as possible, so as not to reduce a volume of the battery and affect the energy density of the battery. In an embodiment, a thickness of the lower housing 1 ranges from about 0.03 mm to about 0.15 mm, and/or a thickness of the upper housing 2 ranges from about 0.03 mm to about 0.15 mm.

Different thicknesses of the housing have different pulling capabilities, and a thicker material has a stronger capability of resisting a bending moment. The thickness of the upper housing 2 is greater than or equal to the thickness of the lower housing 1. Such design can further improve the capability of resisting a bending moment of the upper housing 2, and reduce the deformation of welding.

A welding manner in this embodiment of the present disclosure may be laser welding. In an embodiment, as shown in FIG. 9, melt of the first flange 14 and the second flange 24 just flows into the second concave structure 23 through an emission angle of laser 8 and an angle of blowing the coaxial gas 9.

In some embodiments, as shown in FIG. 1, a rivet 6, an injection hole 5, and an injection hole sealing nail 7 are arranged on the lower housing 1. The injection hole 5 can be sealed by using the injection hole sealing nail 7. In other words, the injection hole sealing nail 7 is used for sealing the injection hole 5.

In some embodiments, an anti-explosion valve is arranged on the housing, to ensure that when an internal pressure of the battery reach a threshold, the anti-explosion valve is automatically turned on, to ensure security of the battery.

Before melting, a distance between the first concave structure 13 and the first flange 14 is equal to the depth by which the second concave structure 23 is recessed inward. In this way, after the first flange 14 and the second flange 24 are melted, the melt 4 is recessed toward an interior of the housing, and does not affect the volume of the entire battery, and the energy density of the battery can be improved. In some embodiments, a height of the melted edge of the melt 4 is flush with a housing body of the upper housing 2, and the melt does not occupy space of the battery, to further improve the energy density of the battery.

An embodiment of the present disclosure provides a battery. The battery includes an electrode core and the battery housing in the foregoing embodiment, and the electrode core is accommodated in the battery housing. A structure of the battery housing herein may refer to the foregoing descriptions, and details are not repeated herein again.

An embodiment of the present disclosure provides an electronic device. The electronic device includes the battery in the foregoing embodiment. A battery housing in the battery herein refers to the foregoing descriptions, and details are not repeated herein again.

The terms “first” and “second” are used only for description objectives, and shall not be construed as indicating or implying relative importance or implying a quantity of indicated technical features. Therefore, a feature restricted by “first” or “second” may explicitly indicate or implicitly include at least one of such features.

In the present disclosure, unless otherwise clearly specified and limited, the terms “mounted”, “connected”, “connection”, and “fixed” should be understood in a broad sense. For example, a connection may be a fixed connection, a detachable connection, or an integral connection; may be a mechanical connection or an electrical connection; may be a direct connection or an indirect connection by using an intermediate medium; or may be internal communication between two elements or interaction relationship between two elements, unless otherwise clearly limited. A person of ordinary skill in the art may understand meanings of the terms in the present application according to situations.

In the descriptions of this specification, descriptions of a reference term such as “an embodiment,” “some embodiments,” “an example,” “a specific example, “or “some examples” means that a feature, structure, material, or characteristic that is described with reference to the embodiment or the example is included in at least one embodiment or example of the present disclosure. In this specification, exemplary description of the foregoing terms does not necessarily refer to a same embodiment or example. In addition, the features, structures, materials, or characteristics that are described may be combined in a proper manner in any one or more embodiments or examples. In addition, different embodiments or examples and features of different embodiments or examples described in the specification can be synthesized and combined by a person skilled in the art as long as no conflict occurs.

The foregoing descriptions are merely exemplary embodiments of the present disclosure, but are not to limit the present disclosure. Any modifications, equivalent substitutions, and improvements made within the spirit and principle of the present disclosure shall fall within the protection scope of the present disclosure.

### REFERENCE NUMERALS

1: lower housing; 11: bottom portion; 12: first side wall; 13: first concave structure; 14: first flange;
2: upper housing, 21: top portion; 22: second side wall; 23: second concave structure; 24: second flange;
3: electrode core;
4: melt;
5: injection hole;
6: rivet;
7: injection hole sealing nail;
8: laser; and
9: coaxial gas.

What is claimed is:

1. A battery housing, comprising:
a lower housing comprising a bottom portion and first side walls, the first side walls extending upward from edges of the bottom portion, the bottom portion and the first side walls enclosing a cavity, and at least one of the first side walls having a first flange on an end of the first side wall away from the bottom portion; and
an upper housing located above the lower housing, the upper housing comprising a top portion and a second flange, a second concave structure being disposed at a joint between the second flange and the top portion, the first flange being in contact with the second flange by welding to obtain melt, and the melt being disposed in the second concave structure.

2. The battery housing according to claim 1, wherein an upper portion of at least one of the first side walls comprises a first concave structure recessed toward the cavity.

3. The battery housing according to claim 2, wherein the first concave structure supports the second concave structure.

4. The battery housing according to claim 1, wherein the battery housing is configured to accommodate an electrode core, and a top surface of the melt does not exceed a top end of the top portion.

5. The battery housing according to claim 1, wherein the second concave structure is circular arc-shaped.

6. The battery housing according to claim 2, wherein the first concave structure is circular arc-shaped, and a width of the first concave structure is about twice a depth of the first concave structure.

7. The battery housing according to claim 2, wherein a depth of the first concave structure is less than or equal to a radius of a chamfer formed between the at least one of the first side walls and the bottom portion of the lower housing, or a width of the second concave structure is less than or equal to the radius of the chamfer.

8. The battery housing according to claim 6, wherein a length L of the first concave structure is determined according to a formula: L=L1−2e−p, wherein L1 is a length of an electrode core accommodated in the battery housing, an intersection of two of the first side walls of the lower housing has an arc shape, e is a radius of the arc shape, and p is a radiation distance of a hardening treatment for the lower housing.

9. The battery housing according to claim 1, wherein the lower housing or the upper housing comprises a metal.

10. The battery housing according to claim 1, wherein a thickness of the lower housing ranges from about 0.03 mm to about 0.15 mm, or a thickness of the upper housing ranges from about 0.03 mm to about 0.15 mm.

11. The battery housing according to claim 1, wherein a thickness of the upper housing is greater than or equal to a thickness of the lower housing.

12. The battery housing according to claim 1, wherein a rivet, an injection hole, and an injection-hole sealing nail are disposed on the lower housing, wherein the injection-hole sealing nail is configured to seal the injection hole.

13. The battery housing according to claim 2, wherein before the welding, a distance between the first concave structure and the first flange is about equal to a depth of a recess of the second concave structure.

14. The battery housing according to claim 8, wherein a range of the radiation distance of the hardening treatment is about 0.2 mm to about 0.5 mm.

15. The battery housing according to claim 2, wherein the first concave structure and the second concave structure have a semicircular shape, and a radius of the second concave structure is about equal to a radius of the first concave structure.

16. A battery, comprising an electrode core and a battery housing, wherein the electrode core is accommodated in the battery housing, and the battery housing comprises:
a lower housing comprising a bottom portion and first side walls, the first side walls extending upward from edges of the bottom portion, the bottom portion and the first side walls enclosing a cavity, and at least one of the first side walls having a first flange on an end of the first side wall away from the bottom portion; and
an upper housing located above the lower housing, the upper housing comprising a top portion and a second flange, a second concave structure being disposed at a joint between the second flange and the top portion, and the first flange being in contact with the second flange by welding to obtain melt, and the melt being disposed in the second concave structure.

17. The battery according to claim 16, wherein the second concave structure comprises the melt.

18. The battery according to claim 16, wherein an upper portion of at least one of the first side walls comprises a first concave structure recessed toward an interior of the cavity.

19. The battery according to claim 18, wherein the first concave structure supports the second concave structure.

20. An electronic device, comprising a battery, the battery comprising an electrode core and a battery housing, wherein the electrode core is accommodated in the battery housing, and the battery housing comprises:
a lower housing comprising a bottom portion and first side walls, the first side walls extending upward from edges of the bottom portion, the bottom portion and the first side walls enclosing a cavity, and at least one of the first side walls having a first flange on an end of the first side wall away from the bottom portion; and
an upper housing located above the lower housing, the upper housing comprising a top portion and a second flange, a second concave structure being disposed at a joint between the second flange and the top portion, and the first flange being in contact with the second flange by welding to obtain melt, and the melt being disposed in the second concave structure.
